(19) United States
(12) Patent Application Publication
(10) Pub. No.: US 2014/0069261 A1
(43) Pub. Date: Mar. 13, 2014

(54) KARAOKE SYSTEM

(71) Applicants: Hwai Sian Tsai, Tsuen Wan (HK); Suk Kuen Wong, Tsuen Wan (HK)

(72) Inventors: Hwai Sian Tsai, Tsuen Wan (HK); Suk Kuen Wong, Tsuen Wan (HK)

(73) Assignee: Eternal Electronics Limited, Tsuen Wan (HK)

(21) Appl. No.: 13/606,274

(22) Filed: Sep. 7, 2012

(51) Int. Cl. G10H 1/36

(52) U.S. Cl. 84/610

(57) ABSTRACT

A karaoke system for establishing a karaoke session includes a karaoke hub coupled to a display and a plurality of mobile devices wirelessly coupled to the karaoke hub. Each one of the plurality of mobile devices includes a corresponding output audio stream associated therewith. The karaoke hub is configured to receive and combine into a single output audio signal the corresponding output audio streams associated with each one of the plurality of mobile devices. The karaoke hub is further configured to transmit the single output audio signal to a display coupled to the karaoke hub.

### TECHNICAL FIELD

The present invention relates generally to interactive multimedia entertainment systems or games, and, more particularly, to karaoke systems.

### BACKGROUND

Conventional karaoke systems consist of hardware specific systems with specialized equipment. The conventional systems are generally significantly limited in terms of their scalability and potential to be upgraded. The conventional systems typically consist of a specifically designed karaoke machine that has a number of microphones and a media player with a display. Karaoke machines can be quite large and expensive. Moreover, conventional karaoke machines are limited by the physical number of microphone jacks included with the machine. In other words, the number of people that can sing at the same time is limited by the karaoke machine configuration.

### BRIEF SUMMARY

According to one aspect of the present invention, a karaoke system for establishing a karaoke session includes a karaoke hub coupled to a display and a plurality of mobile devices wirelessly coupled to the karaoke hub. Each one of the plurality of mobile devices includes a corresponding output audio stream associated therewith. The karaoke hub is configured to receive and combine into a single output audio signal the corresponding output audio streams associated with each one of the plurality of mobile devices. The karaoke hub is further configured to transmit the single output audio signal to a display coupled to the karaoke hub.

According to a further aspect of the present invention, a system for establishing a karaoke session includes a master mobile device coupled to a display and a plurality of mobile devices wirelessly coupled to the master mobile device. Each one of the plurality of mobile devices includes a corresponding output audio stream associated therewith. The master mobile device is configured to receive and combine into a single output audio signal the corresponding output audio streams associated with each one of the plurality of mobile devices. The master smartphone is further configured to transmit the single output audio signal to a display coupled to the master mobile device.

According to another aspect of the present invention, a method of carrying out a karaoke session includes selecting, by application software of a mobile device, a karaoke hub. The method further includes receiving and processing, by each of a plurality of mobile devices, a corresponding sound stream of a plurality of sound streams via a corresponding one of a plurality of microphones. Each one of the plurality of microphones corresponds to one of the plurality of mobile devices. The method additionally includes transmitting, by each of the plurality of mobile devices, a corresponding one of the plurality of sound streams to the karaoke hub. The karaoke hub combines the plurality of sound streams into a single audio stream. The karaoke hub optionally applies audio effects to the single audio stream. The karaoke hub further optionally applies noise and/or echo cancellation techniques to the single audio stream by the karaoke hub. The karaoke hub transmits the single audio stream to a speaker.

### BRIEF DESCRIPTION OF THE DRAWINGS

The foregoing and other advantages of the present invention will become apparent upon reading the following detailed description and upon reference to the drawings.

FIG. 1 is a block diagram illustrating a prior art karaoke system;

FIG. 2 is a block diagram illustrating a karaoke system according to the present invention;

FIG. 3 is a block diagram illustrating another embodiment of a karaoke system according to the present invention;

FIG. 4 is a block diagram illustrating another embodiment of a karaoke system according to the present invention;

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

In the following description, for purposes of explanation and not limitation, specific details are set forth, such as particular embodiments, procedures, techniques, etc. in order to provide a thorough understanding of the present invention. However, it will be apparent to those ordinarily skilled in the art that the present invention may be practiced in other embodiments that depart from these specific details.

The following discussion is intended to provide a brief, general description of suitable computer processing environments in which the methods and apparatus described herein may be implemented. In one non-limiting example, the method and apparatus will be described in the general context of processor-executable instructions, such as program modules, being executed in a distributed computing environment in which tasks may be performed by remote and local processing devices linked via one or more networks. Those of ordinary skill in the art will appreciate that the method may be practiced with any number of suitable computer system configurations and is not limited to the described configurations.

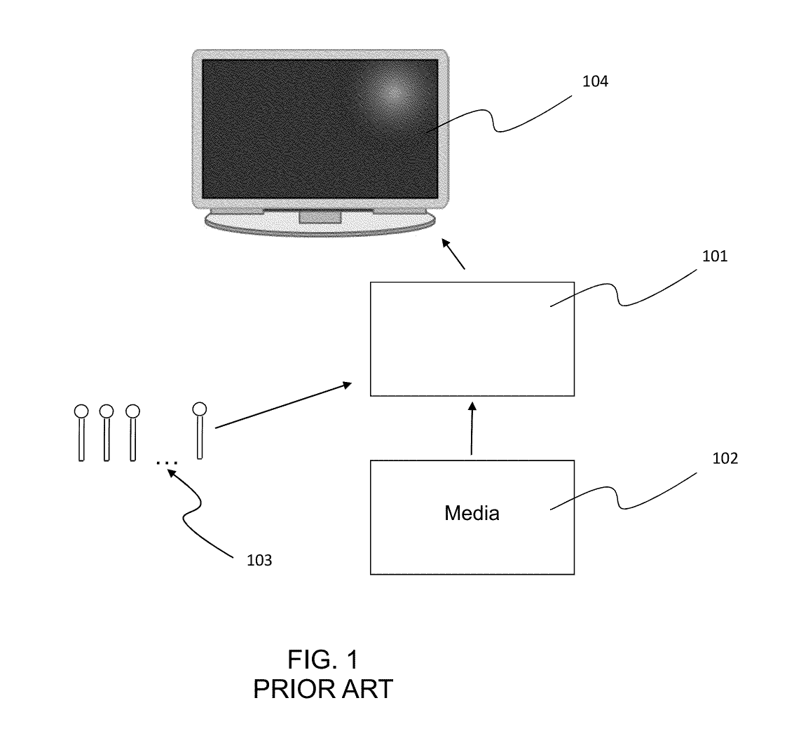

An example of a typical conventional karaoke system is illustrated in FIG. 1. A karaoke machine 101 is connected to a media device 102 and to a display device 104. The karaoke machine 101 has an input from the media device 102 and a fixed number of jacks that can accept microphones 103. The number of jacks may not be modified post production. The karaoke machine 101 can combine (or “mix”) the inputs from the number of microphones 103 and the media device 102 and send the combined data to the display device 104. This display device 104 may include its own speakers or may optionally be connected to an external speaker system.

One aspect of the present invention relates to a karaoke system that uses one or more smartphones and a smartphone software application to achieve a much smaller, scalable and cost reduced (cheaper) karaoke system.

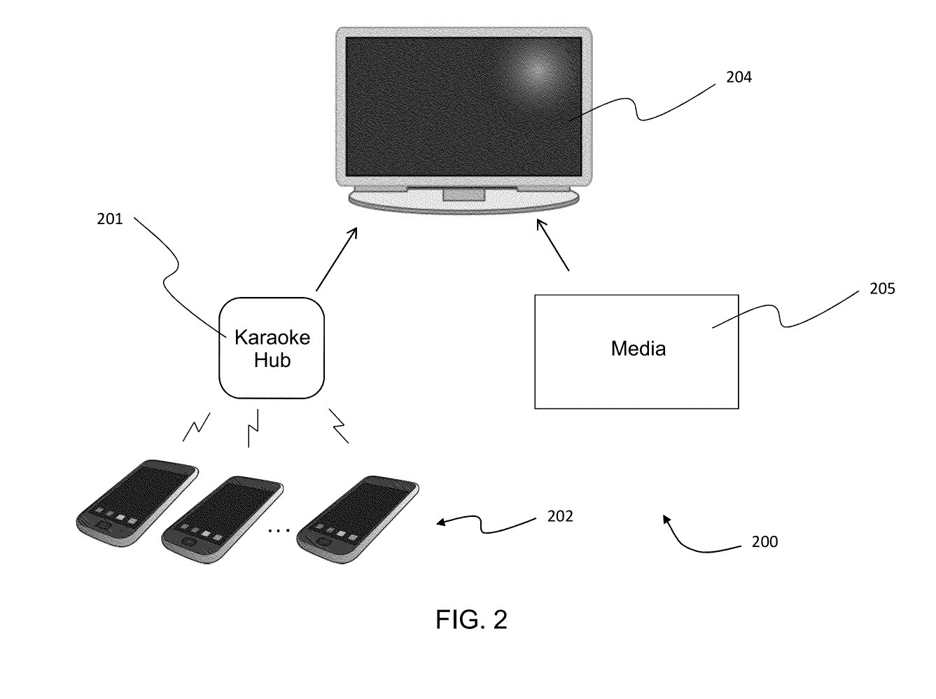

One example of such a karaoke system 200 is shown in FIG. 2. The karaoke system 200 includes a wireless enabled karaoke hub 201 that is configured to wirelessly connect to a number of devices 202. The device 202 may be a smartphone, a tablet, a game console, a personal digital assistant (PDA), a computer, or any other Wi Fi and/or Bluetooth enabled device. During a karaoke session, a user sings into an internal microphone of each one of the plurality of smartphones 202, thereby producing an audio stream associated with each one of the plurality of smartphones 202. According to a further aspect of the present invention, a user of one or more of the plurality of smartphones 202 sings into a microphone coupled to a respective one or more of the plurality of smartphones 202. Each one of the plurality of smartphones 202 has an output audio stream associated therewith. The output audio stream from the plurality of smartphones 202 is transmitted to the karaoke hub 201. The karaoke hub 201 is configured to accept real-time audio streams from the number of smartphones 202 and mix the audio streams into a single audio stream. According to one aspect of the present invention, this single audio stream includes audio effect processing done to it.

According to one aspect of the present invention, the combined single audio stream is converted to an analog stream to be outputted to a display system 204. The display system 204 includes speakers included within the display system 204. According to one aspect of the present invention, the display system 204 is coupled to external speakers. The combined single audio stream is reproduced (played) by the display system 204's speakers or the external speakers. Each smartphone 202 includes an internal microphone. According to one aspect of the present invention, each smartphone 202 may be coupled (directly or indirectly) to an external microphone. Each smartphone 202 includes application software coupled to the processing hardware of each smartphone 202. The application software is configured to couple each smartphone 202 to the karaoke hub 201. A user may download the application software onto his or her smartphone from an application store such as GOOGLE PLAY or APPLE APP STORE.

The application software on each smartphone 202 uses the internal microphone of the smartphone 202 or may optionally use an external microphone. According to one aspect of the present invention, the external microphone is coupled to the smartphone directly or indirectly and includes any suitable microphones known to those of ordinary skill in the art. According to a further aspect of the present invention, the microphone may be coupled to the smartphone 202 via a Wi Fi, BLUETOOTH or USB connection; via the hands-free jack of the smartphone 202 or via any other communication link or channel. The application software is configured to utilize echo-cancellation algorithms to eliminate the sound picked up from the speaker(s), thus removing positive feedback. According to a further aspect of the present invention, the application software also applies some audio effects to the audio stream before the audio stream is transmitted to the karaoke hub 201. As some wirelessly transmitted frames may be dropped in order to maintain a short delay, techniques known to those ordinarily skilled in the art could be applied to lessen the impact of dropped frame to the overall audio quality.

A user enables the application software on his phone by opening the appropriate application on his or her smartphone 202. The user may then select a particular song that the user would like to sing or perform. According to a further aspect of the present invention, the song is pre-selected by a different user. If the song is pre-selected by a second user, the user may receive an invitation to his smartphone 202 to join the second user in singing or performing the pre-selected song. According to a further aspect of the present invention, the display 204 is coupled to a media device 205. The media device 205 includes a user interface, and a user may select an appropriate song via the user interface of the media device 205. Each of the plurality of smartphones 202 is coupled to the karaoke hub 201 via any known communication method, including wireless connections such as Wi Fi and BLUETOOTH. In order to couple to the karaoke hub 201, a user of each smartphone 202 accepts an appropriate prompt on a user interface (such as a display) of his or her smartphone 202. According to a further aspect of the present invention, following initial set-up or sync between each smartphone 202 and the karaoke hub 201, the smartphone 202 and the karaoke hub 201 couple or automatically, thereby allowing users of the plurality of smartphones 202 to begin a karaoke session. The system 200 is configured in such a way that any number of smartphones 202 may be coupled to the karaoke hub 201. Accordingly, any number of users may participate in a karaoke session.

Any existing home stereo system may be retrofitted with a karaoke system according to the present invention. A user installs a karaoke hub by coupling it to the display 204 coupled to the media device 205. The number of users of the karaoke system according to the present invention is not limited—as long as each user has a mobile device 202 with the application software, each user may participate in a karaoke session.

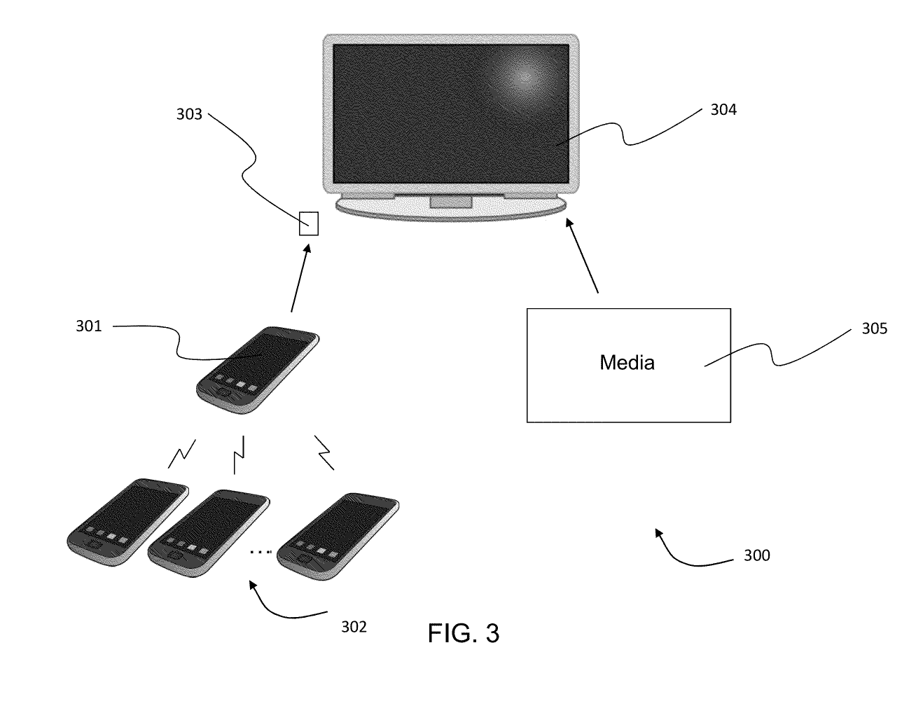

Referring now to FIG. 3, a karaoke system 300 includes a master smartphone 301 and a plurality of smartphones 302. The plurality of smartphones 302 are each coupled to the master smartphone 301 via any known methods, including Wi Fi and BLUETOOTH. The plurality of smartphones 302 and the master smartphone 301 all include application software as described above in relation to FIG. 2 for initiating and carrying out a karaoke session. The master smartphone 301 is selected by users of the plurality of smartphones 302 or by any algorithm known to those of ordinary skill in the art. The master smartphone 301 accepts the real-time audio streams from the plurality of smartphones 302 and mixes the audio streams into a single audio stream. According to one aspect of the present invention, the master smartphone 301 applies audio effect processing to the combined stream.

According to one aspect of the present invention, the combined audio stream is then converted to a single audio stream (which may, for example, an analog or a digital stream) to be outputted or transmitted to the display system 304. The combined audio stream may be transmitted to the display system 304 via a plug-in wire (such as via a hands-free port of the master smartphone 301) to the display system 204. The display system 304 includes speakers built into the display system or coupled to the display system 304. According to one aspect of the present invention, the master smartphone 301 sends the combined stream to speakers coupled to the master smartphone 301. The speakers play the combined audio stream.

According to one aspect of the present invention, the master smartphone 301 is coupled to a wireless device 303. The master smartphone 301 and the plurality of smartphones 302 may be installed with any existing home media system or device. The audio streams are combined inside the master smartphone 301 into a single stream, and may be converted into an analog signal or transmitted wirelessly (e.g., via WI-FI or BLUETOOTH) in a digital form to the wireless device 303. The wireless device 303 converts the single digital audio stream into an analog stream, or converts it into a digital format for outputting to digital interface for a TV set, such as HDMI.

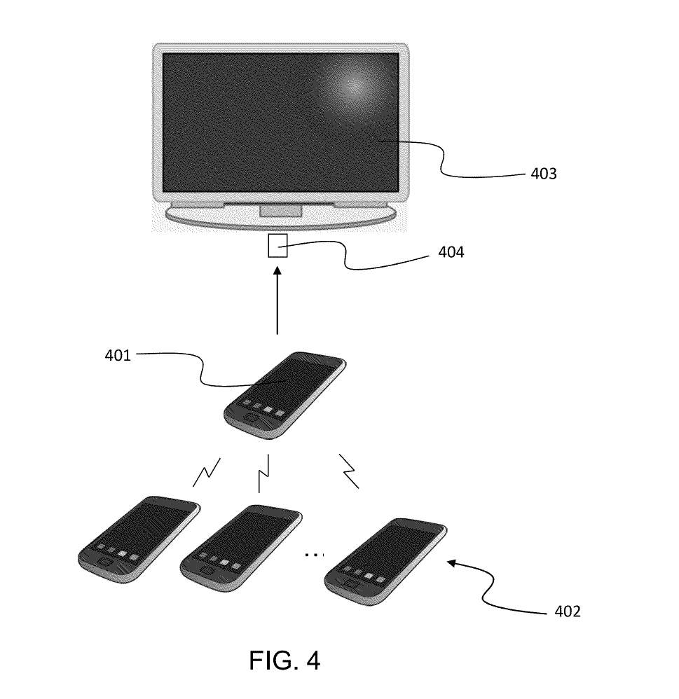

FIG. 4 illustrates a karaoke system 400 including a plurality of smartphones 402 and a master smartphone 401. The master smartphone 401 is selected by users of the plurality of smartphones 402 or by any algorithm known to those of ordinary skill in the art. . The master smartphone 401 accepts the real-time audio streams from the plurality of smartphones 402 and mixes them into a single audio stream. The master smartphone 401 may optionally have some audio effect processing added to it. The master smartphone 401 supplies the media content from either internal storage of the master smartphone 401 or from another source (such as internet streaming) and sends it along with the audio stream to the display 403. The video and audio stream can be sent either in a wired manner (such as via HDMI cable or another other method) or wirelessly to an optional wireless device 404 that converts the data to an acceptable format for the display 403. The combined audio stream can alternatively be sent to either the speakers on the display or an external speaker system or both. According to one aspect of the invention the text or lyrics associated with a particular song during a karaoke session is displayed on a display of each smartphone 402 and/or on a screen of a display system 403

The present invention includes systems having processors to provide various functionality to process information, and to determine results based on inputs. Generally, the processing may be achieved with a combination of hardware and software elements. The hardware aspects may include combinations of operatively coupled hardware components including microprocessors, logical circuitry, communication/networking ports, digital filters, memory, or logical circuitry. The processors may be adapted to perform operations specified by a computer-executable code, which may be stored on a computer readable medium.

The steps of the methods described herein may be achieved via an appropriate programmable processing device, such as an external conventional computer or an on-board field programmable gate array (FPGA) or digital signal processor (DSP), that executes software, or stored instructions. In general, physical processors and/or machines employed by embodiments of the present invention for any processing or evaluation may include one or more networked or non-networked general purpose computer systems, microprocessors, field programmable gate arrays (FPGA's), digital signal processors (DSP's), micro-controllers, and the like, programmed according to the teachings of the exemplary embodiments of the present invention, as is appreciated by those skilled in the computer and software arts. Appropriate software can be readily prepared by programmers of ordinary skill based on the teachings of the exemplary embodiments, as is appreciated by those skilled in the software arts. In addition, the devices and subsystems of the exemplary embodiments can be implemented by the preparation of application-specific integrated circuits or by interconnecting an appropriate network of conventional component circuits, as is appreciated by those skilled in the electrical arts. Thus, the exemplary embodiments are not limited to any specific combination of hardware circuitry and/or software.

Stored on any one or on a combination of computer readable media, the exemplary embodiments of the present invention may include software for controlling the devices and subsystems of the exemplary embodiments, for driving the devices and subsystems of the exemplary embodiments, for processing data and signals, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementations. Computer code devices of the exemplary embodiments of the present invention can include any suitable interpretable or executable code mechanism, including but not limited to scripts, interpretable programs, dynamic link libraries (DLLs), Java classes and applets, complete executable programs, and the like. Moreover, parts of the processing of the exemplary embodiments of the present invention can be distributed for better performance, reliability, cost, and the like.

Common forms of computer-readable media may include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of the invention as defined in the appended claims.

What is claimed is:

1. A karaoke system for establishing a karaoke session, comprising:
a karaoke hub coupled to a display; and
a plurality of mobile devices wirelessly coupled to the karaoke hub, each one of the plurality of mobile devices including a corresponding output audio stream associated therewith,
wherein the karaoke hub is configured to receive and combine into a single output audio signal the corresponding output audio streams associated with each one of the plurality of mobile devices, the karaoke hub being further configured to transmit the single output audio signal to a display coupled to the karaoke hub.

2. The system of claim 1, wherein the karaoke hub is configured to receive and combine into a single analog output audio signal the corresponding output audio streams associated with each one of the plurality of mobile devices.

3. The system of claim 1, further configured to allow a plurality of users to participate in a karaoke session, wherein each of a plurality of users sings into an internal microphone of one of the plurality of mobile devices or into an external microphone coupled to one of the plurality of mobile devices.

4. The system of claim 1, wherein a number of users that may participate in a karaoke session is determined by the number of the plurality of mobile devices coupled to the karaoke hub.

5. The system of claim 1, wherein the display is a television, a monitor, a projector or any other device configured to display images, the display including speakers or being coupled to an external set of speakers.

6. The system of claim 1, wherein the mobile device is a smartphone, a tablet, a PDA, a game console, a computer or any other Wi Fi enabled device, the mobile device including an internal microphone or being coupled to an external microphone.

7. The system of claim 1, wherein the mobile device is configured to employ echo and/or noise cancellation techniques.

8. The system of claim 1, wherein the karaoke hub is coupled to the display via fiber wire, copper wire or wireless communication link.

9. The system of claim 1, wherein the single output audio signal is transmitted wirelessly to the display.

10. A system for establishing a karaoke session, comprising:
a master mobile device coupled to a display; and
a plurality of mobile devices wirelessly coupled to the master mobile device, each one of the plurality of mobile devices including a corresponding output audio stream associated therewith,
wherein the master mobile device is configured to receive and combine into a single output audio signal the corresponding output audio streams associated with each one of the plurality of mobile devices, the master smartphone being further configured to transmit the single output audio signal to a display coupled to the master mobile device.

11. The system of claim 10, wherein the master mobile device is configured to receive and combine into a single analog output audio signal the corresponding output audio streams associated with each one of the plurality of mobile devices.

12. The system of claim 10, further configured to allow a plurality of users to participate in a karaoke session, wherein each of a plurality of users sings into an internal microphone of one of the plurality of mobile devices or into an external microphone coupled to one of the plurality of mobile devices.

13. The system of claim 10, wherein a number of users that may participate in a karaoke session is determined by the number of the plurality of mobile devices coupled to the master mobile device.

14. The system of claim 10, wherein the single output audio signal is transmitted wirelessly to the display.

15. A method of carrying out a karaoke session, comprising
selecting, by application software of a mobile device, a karaoke hub;
receiving and processing, by each of a plurality of mobile devices, a corresponding sound stream of a plurality of sound streams via a corresponding one of a plurality of microphones, each one of the plurality of microphones corresponding to one of the plurality of mobile devices;
transmitting, by each of the plurality of mobile devices, a corresponding one of the plurality of sound streams to the karaoke hub;
combining, by the karaoke hub, the plurality of sound streams into a single audio stream;
optionally, applying audio effects to the single audio stream by the karaoke hub;
optionally, applying noise and/or echo cancellation techniques to the single audio stream by the karaoke hub; and
transmitting, by the karaoke hub, the single audio stream to a speaker.

16. The method of claim 15, wherein the karaoke hub is a master mobile device.

17. The method of claim 16, wherein the master mobile device is configured to receive a master sound stream from a microphone associated with the master mobile device.

18. The method of claim 17, wherein the master mobile device is configured to combine the plurality of sound streams and the master sound stream into the single audio stream.

19. The method of claim 15, wherein each mobile device includes an internal microphone or is coupled to an external microphone.

20. The method of claim 15, wherein the speaker is coupled to a display.
